(19) United States
(12) Patent Application Publication
(10) Pub. No.: US 2016/0189303 A1
(43) Pub. Date: Jun. 30, 2016

(54) Risk Based Automotive Insurance Rating System

(71) Applicant: Gil Emanuel Fuchs, Nes Tziona (IL)

(72) Inventor: Gil Emanuel Fuchs, Nes Tziona (IL)

(21) Appl. No.: 14/460,868

(22) Filed: Aug. 15, 2014

Related U.S. Application Data
(60) Provisional application No. 61/968,904, filed on Mar. 21, 2014.

(51) Int. Cl. G06Q 40/08

(52) U.S. Cl. CPC G06Q 40/08

(57) ABSTRACT

A method and system for determining the risk associated with providing vehicle insurance. A database is compiled that contains historical information pertaining to vehicle and driver activities and risk factors associated with elements of a road network. The historical information may include, for example, accident counts, and weather and road conditions during the accidents. A statistical predictive relationship is developed to estimate insurance risk as a function of the historical information for each road element. During driving, vehicle and driver activity are monitored and subsequently, insurance premiums are calculated based on the developed model and when and where a vehicle and/or driver travel. The model is periodically updated and refined.

### CLAIM OF PRIORITY

This application claims the benefit of priority to U.S. Provisional Patent Application titled “Risk Based Automotive Insurance Rating”, Application No. 61/968,904 filed on 16 Apr. 2014 which is herein incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF INVENTION

This invention relates to determining vehicle insurance risk and more specifically to development and usage of an insurance risk database that is referenced to elements of a transportation network.

### BACKGROUND

There is a need in the automotive insurance industry to accurately predict the risk of claims being made and the costliness of claims being made and adjusting the insurance rate charged to an individual or for a vehicle accordingly. The more accurate the prediction, the lower the premiums can become, making the insurer more competitive and presumably profitable, and/or the insurer may choose to not insure individuals or vehicles of the perceived greatest risk or smallest profit potential.

It is known in the art to base premiums on such thing as the geographic area where a driver lives, or potentially the area s/he drives through on a regular basis. It is also known to further evaluate rates based on the historical location and frequency of accidents, crime rates, traffic flow and/or claims made in the vicinity of geographic area used as a rating territory. It is further known to adjust the rates based on the drivers past driving history with respect to insurance claims and driving record.

One of the many problems with existing insurance risk rating systems is that they are too granular or non-specific. For example, typically a geographic area for rating would be based on the address of the owner of the vehicle. This would mean that all the residents of a given area or neighborhood would be lumped into the same rate category. These rates could be adjusted for factors such as the type of car being insured on how expensive claims are for that particular type of car in the area of interest, however this type of rating system generally does not take into account the areas typically driven through on a regular basis by the driver.

Another issue with current insurance risk rating systems is that assumptions made in the systems may not be valid. For example, most would agree that if a person obeys the traffic laws, then that person's driving risk would be less. This may not be the case and the embodiments of the present invention make no such assumptions.

There is a need in the industry to have a vehicle insurance risk system based on one or several parameters that are spatially referenced with respect to the transportation network the vehicles travel on and further based on the driving habits of individual drivers that are insured or desire insurance. Knowing when and where a driver drives and knowing the historical risk associated with driving a given route at a particular time, a formula can be derived to predict risk for individual driver which in turn can be used to set rates. Because the parameters related to driving/insurance risk and driving habits of a given driver are associated with transportation system elements in the present invention, a more refined model of risk is possible than for insurance risk solutions in the art. Determining premiums based on a single point or region (for example a residential address) does not take into account where a person drives on a regular basis.

As the correlation between one or more risk parameters and insurance risk may vary over time and may vary regionally, it may be needed to statistically analyze the parameters used in a model and continually change them over time. In addition, historical parameters used may lose relevance with time and will need to be retired or withdrawn from the determination of risk—relying on more recent data.

Real time information (while the insured is driving) may be much more relevant to risk. For example, if the road is icy, the likelihood of making a claim is potentially higher, than if the only information available is that is likely to be icy at the timeframe when driving.

With a dynamic rating system that is continually updated and also has a real-time component, it is further possible to compel drivers to adjust driving habits based on the real-time information to reduce the risk. For example, if a particular route is known to be icy, and the course the driver is taking is being monitored, and the monitoring system further suggest an alternate non-icy route, then the driver can be rewarded for avoiding risky conditions by a reduced premium, or by monthly rebate checks or similar.

Real-time information can come from a variety of sources such as wireless acquired weather information and traffic reports. This information can further be statistically aggregated to produce historical weather/traffic risk information likelihood indices that are spatially and temporally indexed. Metadata associated with the historical information can then be used to cull older information and continually update the indices with the latest information. Also continuous, real time, accumulation of accident reports with root causes can be helpful to assess and distribute that risk across the total driving space of some geographic region.

### GLOSSARY

Driver Insurance Risk: The probability that an insured will make a claim and for how much given a variety of measured factors. It could also refer simply to the probability of being in an accident.

Transportation Network: A system of road, streets, paths, sidewalks, trails, waterways or other ways that a vehicle or pedestrian travels along. A transportation network can be subdivided by the type of vehicle or pedestrian that is intended to be used for. For example, roads and streets may be used by cars, trucks and busses. Trails and sidewalks may be used by pedestrians and perhaps bicycles. Transportation networks are generally stored in a Geographic information System that documents the location and interaction of various components of the transportation network. Attribution is also associated with the various components of the network.

Element: Is a distinct component of a transportation network that has an associated geographic coordinate/s. Examples of elements are road segments where the road begins and ends at an intersection; an intersection between two or more roads; or the boundary of a lake.

Attribution: Attribution associated with a transportation network includes any piece of information that can be related to a spatially referenced element or component of the transportation network. Examples are such things as speed limits, number of lanes, connections between components, or type of vehicle that can traverse the component. Attribution, in addition to being spatially referenced may have a temporal (time) component expressed as, for example, time of day, time of week, or time of year. An example of this is the speed limit in a school zone.

Metadata: Metadata is a special kind of attribution associated with the quality of components of transportation network. Metadata can be associated with individual geographic components, attribution or the source of the geography or attribution. Metadata may be associated with precision or accuracy of the components or source. Metadata may have a component that list the age of the source.

Index: Two Meaning are Used:

1) With respect to a hazard index, this is another way of stating the probability that some hazardous incident could occur on a given road segment, but stating it in a more granular fashion rather than percentage, for example, High, Medium or Low. In addition an index can represent one or more values used to multiply or otherwise adjust up or down a baseline value. For example if a prospective insured base premium is $100, discounts and/or increases to the base may be applied by multiplying the base by a crash index, a driver age index, a safe driving index or a single index that is based on a number of parameters.
2) With respect to a database, if an attribute of a database entry allows selecting or sorting of the database elements, then it is referred to as an index. For example, to get a list of all the accidents that occur on the weekend, then you would select accident that have a day of week attribute that is either Saturday or Sunday.

Maneuver/Complex Maneuver: A maneuver is an attribute associated with an action that can be either perform or not performed and which is associated with one or more components of a transportation network. For example, a no-left-turn at an intersection is an example of a prohibited maneuver. A complex maneuver is generally associated with more than one component of a transportation network—for example, what is known as a Michigan Left Turn, in which a vehicle desires to turn left at an intersection, but in order to do this has to turn right, cross one or more lanes, then cross a median on an avenue, then turn left, is a complex maneuver.

Parameters: Any factor that may be directly or indirectly be related to insurance risk.

Geocode: Process of taking a street address and determining a geo-referenced coordinate usually a latitude and longitude and further determining the associated transportation segment associated to the street address.

Snapping: Refers to the process of finding the nearest transportation segment (via perpendicular distance) to a given geo-spatial coordinate location.

Multivariate Analysis: A class of statistical analysis used to determine the relevance of one or more parameters in predicting an outcome and used to build a predictive function base on one or more of the analyzed parameters. In this case the outcome is the prediction of insurance risk or driving hazard assessment. An example of a multivariate analysis is an Artificial Neural Network (or simply a neural network). Another example is any form of machine learning.

Threshold: In multivariate analysis, several factors contribute to the predictive model. Some factors can be more relevant or more influential than others. For example the number of accidents in the past along a particular road segment, may be a better predictor of insurance risk of driving that segment than the average vehicle speed along the segment. However a relative weighting of the two parameters may predict better than either one used singly. So if a predictive model, when using a particular factor in the prediction, does not perform appreciably better than if the factor was not incorporated in the model, the factor can be removed from consideration. When this happens is when the difference in the two predictions is less than a preset threshold value.

Accident Count: The number of accidents that occur for a given element of the transportation network over a given time. This may be further subdivided based on weather conditions and/or time of day, time of week or based on other attributes that may influence accident occurrence.

Incident: A single occurrence of a measured parameter. For example an individual accident report is an incident of the parameter accidents; a recorded speed of an individual driver along a segment of road is an incident of speed of travel for that segment.

Granularity: This term is used to refer to the specificity of either an attribute or index. For example, if an accident count is based simply on the transportation element it took place on, it is less granular than if the accident count is based on the location (element) and the time.

Insurance Risk: This term is used collectively for all embodiments of the present invention to encompass the desired outcome of an insurance risk model. Examples of desired output are the probability of: having an accident, making an insurance claims, or making an insurance claim within defined monetary limits.

Crowd Sourced: Information that is gathered from voluntary (or otherwise) information that is contributed to a website or webservice via an internet link. This information can be anything from verbal reports concerning traffic, to GPS trails that observe a drivers location and speed in real-time, which can then subsequently be used to update maps and other information pertaining to traffic or hazard.

Outside Sourced: all sourcing of risk factor information that are not part of vehicle tracking and sensor analysis. This can include crowd sourcing, police reports, accident reports from insurance and/or police, weather from weather bureaus or crowd sourced, pavement conditions from highway departments or state government, traffic data from published or crowd sourced services and many others.

Statistically Significant: refers to a minimum amount of information that can be used to achieve acceptable predictions of risk or hazard. For example if a predictive function relies heavily on a variable such as the average speed of vehicle passage for each road segment, then wherever there is no information concerning the average speed for any segment, then an average speed would have to be assumed. You could default to the speed limit for example. The more road segments that have an estimated average speed, the poorer the prediction of risk will be. A threshold needs to be in place to exclude information that is below a pre-defined value of percent coverage.

Statistical Relevance: in any form of multivariate analysis, one or more measurements or parameters are used to predict an outcome. In this case an outcome is the risk associated with driving along a transportation element. In the process of developing the prediction function, it may be found that removal of certain parameters or measurements from the predictive function, does not appreciably change the prediction. A threshold can be set, pertaining to how much a specific parameter influences the prediction and if the correlation between an actual outcome and the predicted outcome does not improve about the threshold, then the parameter can be dropped from consideration. This is not to say that it could not be re-introduced when more or better data is available, or used in other geographic areas.

Sensor derivative: Sensors that are incorporated in a vehicle or are within a vehicle (accelerometers in a smartphone where the smartphone is in the vehicle for example) can have the output evaluated and turned into a parameter. For example if an accelerometer indicates rapid acceleration in the direction of the front of the vehicle and a tire spin sensor records an event, this may be registered as a sensor derivative called dangerous acceleration. If there is a rapid acceleration to the left followed by a rapid acceleration to the right, this may be registered as a dangerous lane change event.

Below are examples of elements of a vehicle insurance risk database. Some or all of these elements may be used to develop a risk model or risk indices.

Standard GIS Road Network Including:
Road Segments
   Geography typically stored as a series of end nodes locations, and a series of shape points (internal points that define the location of the segment) or as a geometric function.
   Attributes Stored relative to a node or the segment as a whole
   (Road segments typical have an end node at the intersection with another road segment or a political boundary or a geographic feature.)
Intersections
   Geography may be stored as either a singularity or a series of point and lines which make up a complex intersection (such as a highway cloverleaf)
   Attributes are stored that are associated with the intersection and/or the connecting segments
Maneuvers (including complex maneuvers)
   Geography usually stored as a reference to one or more geographic components that make up the maneuver
Attribution Examples (all attributes may have multiple values base on time and may also have metadata associate with them):
   For Segments:
      Speed limit/Actual Speed Driven
      Accident Count
      Historical Traffic Flow/count
      Historical Weather Information
      Number of Lanes
      Vehicle Type Access
      Street Side Parking
      Elevation/Change in Elevation
Railroad crossing
Political Boundaries
Parking Areas

Historical Data
Crimes associated with a location (snapped to road segment or intersection); time of data; time of year
Accidents: type of accident (solo or collision); location, direction of travel; date, time of day; type of vehicle; weather; driver record
Previous Claims: location; type of claim (accident; vandalism; car-jacking); amount of claim; type and age of vehicle.
Police citations: location, type
Weather: ice, temperature, wind, pressure, snow, rain, flooding

### BRIEF SUMMARY OF THE INVENTION

A primary object of the present invention is a method to develop a database comprising parameters that are related to insurance risk and/or driving hazard to be used for vehicle insurance rating and/or pricing and furthermore, where the parameters are related to transportation network elements.

Another object of the invention is to determine which parameters or combination of parameters best predicts insurance risk for individual drivers or individual vehicles.

A further object of the present invention is a maintenance and update method for the above mentioned databases.

Yet another object of the present invention is to track and parameterize the driving habits of individual drivers and to compare those driving habits to historical parameters and habits of other driver in order to predict individual insurance risk or driving hazard.

It is a further object of the present invention to influence the driving habits of individual drivers by suggesting safer routes or driving habits and to reward or penalize individual driver based on their utilization or lack of utilization of suggestions.

It is an object of the present invention to develop a system that comprises a database, software and hardware to predict insurance risk or driving hazard, to mitigate insurance risk or driving hazard while individuals are driving and to set insurance premiums based on the database and real-time input.

It is an object of the present invention to develop an insurance rating system based on accident counts for individual elements of a transportation network and how frequently a driver travels elements with accident risk.

It is an object of this invention to display driving hazard or insurance risk relative to transportation segments on a map of a transportation network.

It is an object of this to route from an origin to a destination taking into account hazards and risk data from the hazard/risk database.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a flowchart of a an embodiment showing how to initially develop a historical insurance risk or traffic hazard database used to determine initial premiums.

FIG. 2 is a flowchart of an embodiment of data reduction and input of data from disparate sources into a central database.

FIG. 3 is generic flowchart of multivariate analysis and model development.

FIG. 4 is a flowchart of an embodiment to determine individual driver accident risk.

FIG. 5 is a flowchart of how to compel a driver to minimize insurance risk or driving hazard risk in real-time and thus reduce insurance premiums going forward.

### DETAILED DESCRIPTION OF THE FIGURES

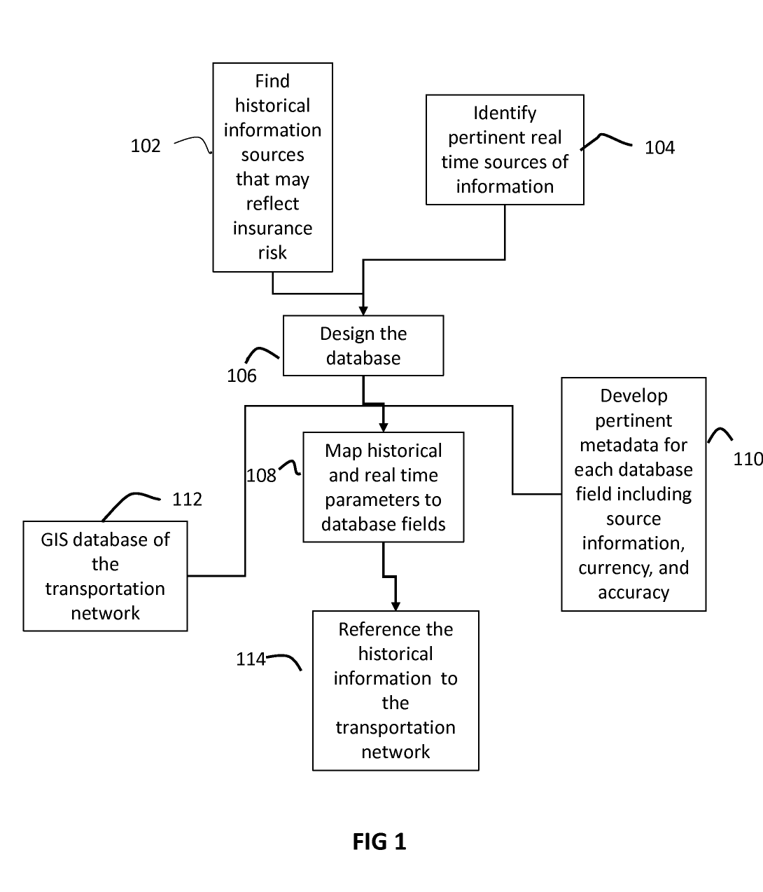

FIG. 1 shows one method of how to initially construct a spatially referenced database, to be used to predict insurance risk and driving hazard, based on existing historical information. A database of historical information is needed in order to determine baseline insurance premiums and also amass hazard information based on time and location. Different information may be available different locations. The development of the database assumes no strong correlation between any parameter and risk. For example an individual may consistently drive over the speed limit, but yet still be a safe driver—therefore, at least on an individual level, fast driving may not have a strong relationship to insurance risk or driving hazard, however as a whole, drivers in general may be a larger risk if they drive fast.

It is not presumed that relationships between parameters and risk hold true over large areas—there may be locally relevant predictors that are not as significant as in other areas. Certain historical datasets or parameters may not be as readily available in some areas as they are in others. For example, reports documenting accidents and accident locations may be more readily available and more easily input into a database for an urban area than for a rural area. Or accident reports may not be available, but traffic counts which may indicate accidents may be available.

Ideally the attribution used for insurance rating will be easier to deal with if it is consistent throughout the entire rating area. To accommodate this, it may be necessary to approximate a parameter stored in the database with input from a related parameter. For example, from the previous paragraph, you may wish to store accident occurrences associated with each road segment. If accident reports are not available for an area of interest but traffic flow information is, you may be able to infer that while traffic stops or slows way down that this is caused by an accident. This could then be reflected as an accident occurrence. This inferred accident occurrence could further be reflected in the metadata as the source for the accident count and an indication that the count is less reliable than an actual accident count. Another means of getting the proxy is the road quality, like road maintenance, and quality of the road surface type.

Accordingly as shown in FIG. 1, the first step 102 is to find sources of historical information that potentially can be used singly or in tandem with other parameters to predict insurance risk and driving hazard. As pointed out above, the sources of information may vary locally, but it will be necessary to combine or map 108 the information from different sources that represent the same parameter into a single database field.

Any model or predictive function could be greatly influenced by information that is acquired in real-time or near real time from drivers. This information could comprise things such as speed of travel, braking, engine function, acceleration, route taken and many others. If this information is readily available, it will influence the design of the predictive database. Therefore sources of pertinent real time information need to be identified 104. Real-time information could come from insurance subscribers that opt into an insurance plan that mandates monitoring or could be crowd sourced by volunteers. Additionally real-time information could come from sources such as commercial traffic information providers or local government highway or police departments.

Based on what historical information that is available and what quantity there is and what type of real time information can be acquired, the database schema or design can then be created 106. All parameters to be stored in the database will be geographically referenced 114 relative to an underlying GIS database 112 of the transportation network. Certain parameter (for example a speed limit) may also be temporally referenced.

Once a rating system is running based on the database, some of the data in the database may be retired based on age or when more accurate information becomes available. Therefore metadata about the age and quality of the data needs to be documented 110.

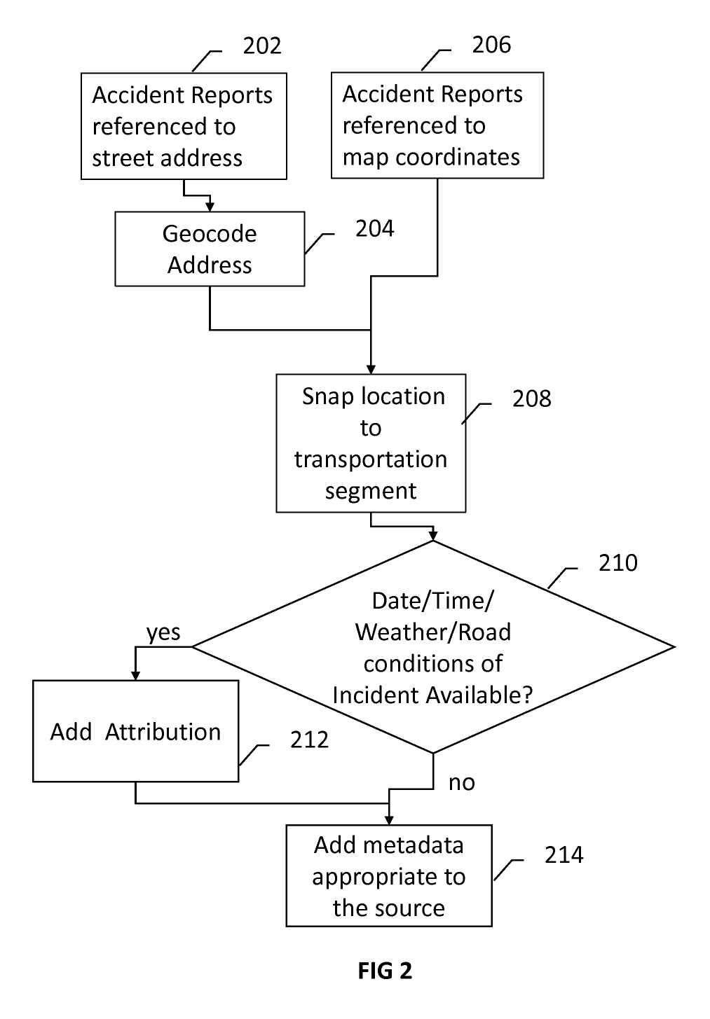

FIG. 2 shows an example of how disparate information is combined into a single layer in the risk database. The example is given for accident reports but the technique also applies to any type of attribution. As accident reports initially come from local police departments and/or directly from insurers, the format of the information and availability varies between departments or companies. For example, one department will have available accident reports that are geographically referenced to a street address or an intersection 202 and another department will have accident reports referenced to geographic coordinates 206, for example, latitude and longitude. In an embodiment of this invention, risk attribution is referenced to components of the transportation network, for example street segments or intersections, with possibly also direction of travel. Therefore the frame of reference of the incoming accident reports need to be translated into the frame of reference of the database. For accident reports geographically referenced to a street address or intersection 202, the reference must be geocoded 204 so that the segment or intersection can be associated (snapped) 208 with appropriate road segment or intersection in the database. If the incoming accident report is referenced to map coordinates 206, then this location can simply be snapped 208 to the nearest street segment or intersection.

As is well known, the probability of an accident will increase with increased traffic density and/or due to inclement weather. This information may be available 210 with incoming accident reports or may be available via other sources such from a weather service which then can be related to an accident incident via location and time.

The probably of an accident may increase based on the time. For example the probability of an accident most likely increases at 2 AM (2:00) on New Year's day as opposed to any other day at the same time. Therefore any form of attribution that can be associated with an incident should be added 212 so that it can be analyzed to see if there is any correlation with risk.

The granularity of associated information will vary. For example if a traffic flow was associated with a particular accident and that traffic flow information was acquired from a Traffic Messaging Channel (TMC), this information may not be associated with the exact location of the accident and therefore may be suspect. The quality of the associated attribution for accident reports needs to be documented as metadata 214.

It should be noted that initially accident reports (and other parameters) would come from historical data such as police reports, however, this could be supplanted by real time information coming from vehicle sensors. For example, if an insurance subscriber allowed access to the insurer for output from car sensors, an accident incident could be recorded at the gps location of the vehicle when there was signal indicating that the air-bag was deployed. Once again the source of the report or parameter should be included as part of the metadata and be used as a measure of quality. Other driving telemetry obtaining devices which may be installed on the vehicle (perhaps at the behest of the insurance company) would be used to obtain additional pertinent information.

Examples are shown below of incidents that can be recorded in a risk database and which can subsequently be used to determine driving/insurance risk. Examples of associated attribution are also provided. These are examples only and is not an exhaustive list.

Accidents

Crime

Tickets

Vandalism

Insurance Payout; Fault (victim or perpetrator)

Road Condition (Potholes, pavement temperature, lane marking, etc.)

Road Surface Type

Traffic Counts

Weather Events (Ice, Snow, Rain, Fog, Smog, Temperature)

Driver Distracted? Also visibility of curves, signs, traffic lights, warning signals

Traffic Flow
Volume of Traffic
Speed of Traffic/Excess Speed
Lane Closures
Detours
Related Accidents

The following list are examples of information that may be recorded for an individual driver and may come from either/or questionnaires or real-time sensor information: Type of car; where you drive; when you drive; snow tires during winter; previous tickets

Real-time tracking allowed by the vehicle driver?
GPS, bluetooth usage (ie cellphone); rapid acceleration; braking; airbag deploy; speed; other driving telemetry devices installed in car (accelerometer, gyroscope, compass)

Air Bag Deployment

Rapid Acceleration/Deceleration

Swerving from lane

Segments and intersections traversed including time of day; time of week; speed; braking; acceleration; lane changes; crossing the median; bluetooth usage

Stopping locations; duration

Associated weather

Once a historical database of incidents, for example, accidents and traffic violations is developed and referenced to transportation elements, then analysis can be performed to determine relationships to risk and hazard. Once again, no a priori assumptions are made about a correlation between a particular parameter and risk other than initial assumptions that are made to run and test a multivariate model.

In an embodiment, incidents are evaluated based on the quantity and quality of information available and also the extent over which the information is available. The goal is to create a risk and/or hazard index or indices based on one or more of the type of incidents recorded related to elements of the transportation network.

In an embodiment, what is desired, is a function to predict the likelihood that a given driver will make an insurance claim and for how much or for example the likelihood the driver will be involved in an accident. The likelihood of claims and cost of those claims or the likelihood of being in an accident can be a function of:

Time

Location (for driving and parking)

Driver Performance

Road Conditions

Weather

Traffic Volume

Crime Statistics

Type of Vehicle

Number of passengers

Vehicle condition

These parameter can be further broken down into:

Time: time of day, time of week, time of year, holidays; daylight/nighttime

Location: relative to a transportation segment, geographic location, within a political boundary
If monitored with car sensors (where a vehicle is left overnight; where and when it is driven);

Driver Performance:
If monitored using in-vehicle sensors while driving: amount of distraction (mobile use); driving above or below speed limits; weaving; rapid acceleration; road class usage; and duration
From records: accident reports; speeding and other violations

Road Conditions:
From records: potholes, sanding/salting during storms; plowing frequency; number of police patrols ; visibility issues (like proper lighting at night, or blinding sun in eyes)
From vehicle sensors: bumpiness; storm conditions; ABS braking engaged; differential slip

The factors that may influence the number and amount of insurance claims or the risk of being in an accident may be exceedingly complex. This is why the analysis lends itself to a form of multivariate analysis. Typically a human can only visualize the relationship between 2, maybe 3 variables at a time and a parameter my not be directly related to a cause of an incident, but may provide an indication of the cause. For example in one area, it may be found that the instance of traffic accidents at 2 AM is far greater than in another area. Therefore you could conclude that time of night is not a very good overall predictor of having an accident. However if you also observe that in the first area, the instance of arrest for drunk and disorderly is higher than the second area, the combination of time and arrests for intoxication, may be a much better predictor. If yet more variables are introduced, then the relationship may get more complicated and more poorly understood without some form of multivariate statistical correlation.

In another example the quality of the information will influence the predictive model. It is well known that ice formation on a road is a function of temperature, humidity and barometric pressure. However if the weather conditions in an accident report are based on the general weather conditions for the region from a weather report, this data will not take into account, subtle weather variations that may be available from in-car sensors. A difference of a degree in temperature could make the difference between ice and no ice.

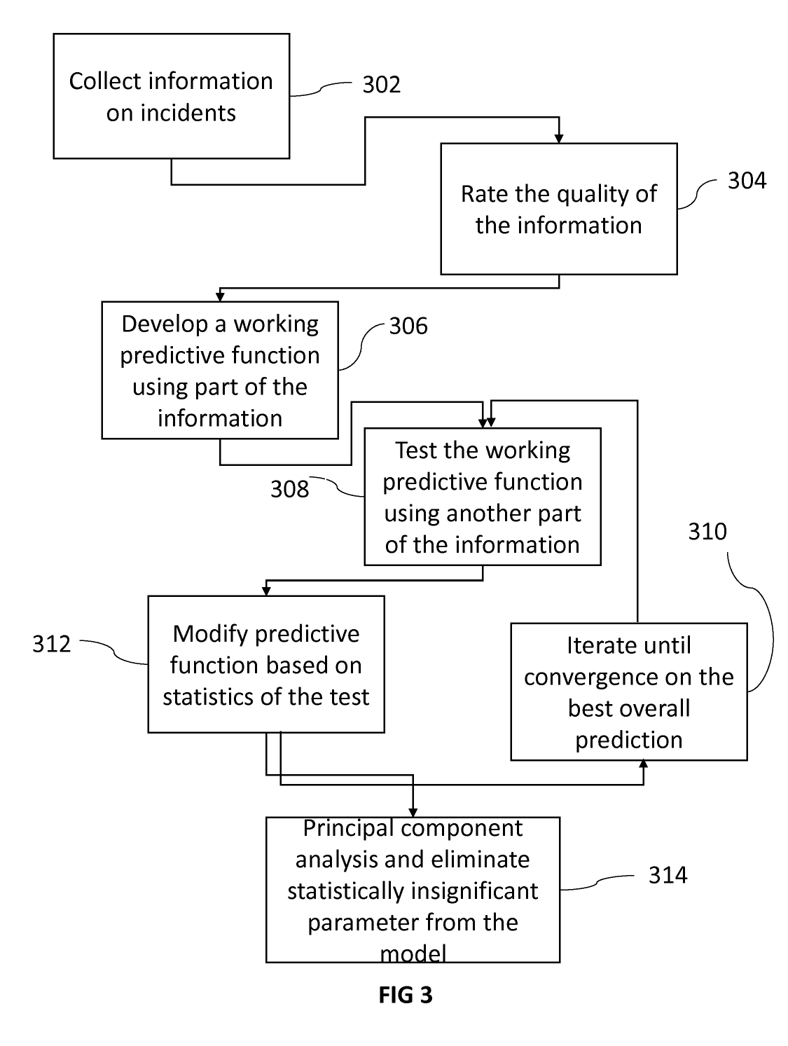

As shown in FIG. 3, once an initial database is constructed with some or all of the above listed information 302, then a predictive model needs to be developed. When collecting data, care must be taken to not duplicate the same incident that is recorded in multiple sources. A statistical significance of the measurement parameters needs to be evaluated with respect to insurance risk 304. For a given geographic area, it must be ascertained whether or not there is enough data to make a meaningful correlation and whether that data is of sufficient quality. If the data is of mixed quality, as in the freezing pavement example above, then quality must be taken into account for the overall general model. This can be done by setting a minimum threshold data quality where a dataset must contain quality data for a specified percentage of the transportation elements within the region of interest.

It is desirable to have as much granularity in the observed information as possible in order to determine what information correlates more strongly to risk and hazard. Using the accident report example, we want to predict insurance risk. Therefore, for all the accidents that occur in a region, if we have information on the insurance pay-out, a model can be developed that uses part of the information as a training set 306, for example in a neural network predictive model known in the art and part of the data to test the prediction 308.

In many multivariate analysis methods, initial assumptions need to be made to come up with a working predictive function 306. For example, initial weighting or correlation values might need to be assigned to the input variables. An educated guess may be that the number of pot holes in a road is about half as important to risk as the number of drunk driving arrests.

Once an initial model is generated, an iterative process 310 is used to converge on a reasonable predictive model. This is done by modifying the weighting of input parameters slightly 312, then rerunning the new predictive function and observing the correlation statistics until an optimal correlation is arrived at.

In an embodiment, the input for a model may need to be parameterized in such a way as it can be used into a model. An example of parameterization would be to characterize incidents into a grouping. For example, it may be desirable to collectively refer to accidents counts falling into a range of 1-10 accidents per year as a “low” accident count and have “medium” and “high” counts as well.

As was previously pointed out, the parameters that could be used to predict insurance risk and/or driving hazard and the resulting model could be exceedingly complex. Compiling information from a variety of sources to populate a given parameter may be difficult and if available data is insufficient, may also result in a poor prediction. Therefore, in order to keep the cost of the rating system low and to facilitate rapid development, it may be desirable to limit the data/parameters that are utilized and make some simplifying assumptions.

In an embodiment, the assumption is made that insurance risk for driving on a particular transportation element is directly correlated to the number of accidents reported on that element over a set time period. Therefore the risk database could simply contain accident incidents that are related to individual transportation segments. If available, additional attribution that may be recorded with accident incidents are, for example, direction of travel, time of day, date, and weather variables. In this embodiment, it is further assumed that insured drivers have agreed to have their driving habits monitored. If the person is applying for insurance, an initial insurance premium could be based partially on the area of residence and some average of accident risk within a geographic radius of the residence. Alternatively or after an initial rate is applied, the weekly habits (or longer duration) of the driver could be monitored. By monitoring when and where the driver has been, then, for example, it could be determined all the transportation elements the driver has traversed for a given rating interval and how many times they have been traversed.

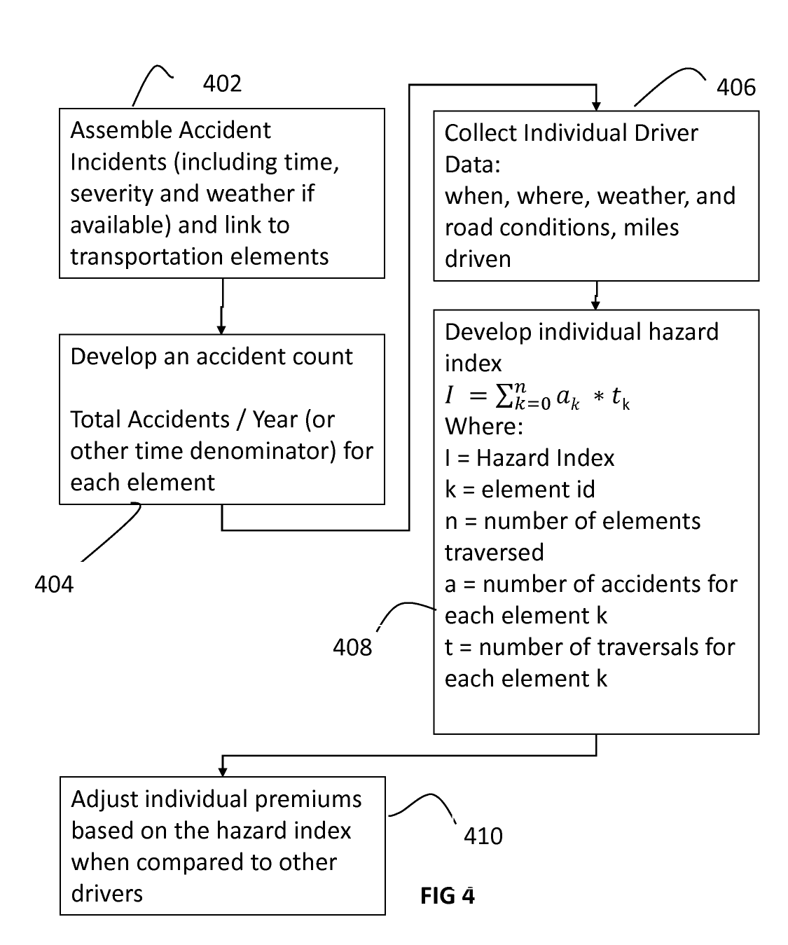

As shown in FIG. 4, this embodiment would comprise assembling an accident incident database and linking accidents incidents to transportation elements 402. If any additional information is available such as the time of accident, the severity of the accident, the weather or pavement conditions, this should be included as associated attribution. Based on the incident information, an accident count could then be developed 404 which in its simplest form would be the average number of accidents that occur on each transportation element over a given time period. If other attribution is available, then the accident count could be further subdivided based by separating data, for example, for a given time of day or time of week, thus having multiple accident counts per transportation element. If severity information was available, then accident incidents could be weighted in the accident count, for example, an accident with a fatality could be counted as 10 times a minor accident.

To determine an insurance premium based on the above accident counts, then the risk associated with an individual's driving habits needs to be assessed. The can be done by collection of data while an individual is driving 406. Data to be collected comprises when and where a person is driving and then relating that information to the transportation elements a person drives on and the frequency they drive on them. From this information, a basic Hazard Index (I) can be developed 408. In its simplest form, the Hazard Index is the summation of the accident count for all elements traversed multiplied by the number of traversals for a given time period. Finally insurance premiums could be adjusted based on the individual Hazard Index when compared to other individuals.

Yet more refinement of an individual Hazard Index could be made by further subdividing the index based on additional attribution such as weather and road conditions provided that the accident count database has this amount of granularity.

As more drivers are monitored, gradually, historical data gleaned from accident reports could be replaced by, for example, air bag deployments sensor information from insured drivers. The air bag deployment could be related to accident occurrence and severity and would make it unnecessary to acquire accident information from other sources such as accident reports from the police.

Granularity can be further increased by further analysis of recorded data about the vehicle. For example, there is possibly a correlation between driving behavior just prior to an accident and the probability of the accident happening. So if a driver is accelerating rapidly or changing lanes frequently, this may indicate increased probability of having an immediate accident.

In an embodiment of the present invention, once a database of insurance risk is established and maintained with current information, then commercial risk products can be created that map the associated driving risk to transportation elements. This product can be sold to municipalities and other entities responsible for safety on transportation networks.

Yet another embodiment of the present invention is a method to reduce driver/insurance risk utilizing one of the above described risk and driver habit databases and monitoring of a driver activities and habits in real-time. The system utilizes a navigation device located in a vehicle. The navigation device is either in communication with a risk database and a driving habits database or the databases are stored within the navigation device. The navigation device can be integral to the vehicle, a stand-alone device or software implemented on a computer, smartphone or tablet device. Generally location is determined by a GPS which is part of the navigation device. Based on former analysis and part of the driver habits database, the system pre-determines routes that the driver in question has historically taken. It further determines the propensity of the driver to deviate from safe driving habits such as driving faster than the speed limit or swerving in the other lane or using a mobile phone (as determined from blue-tooth usage for example).

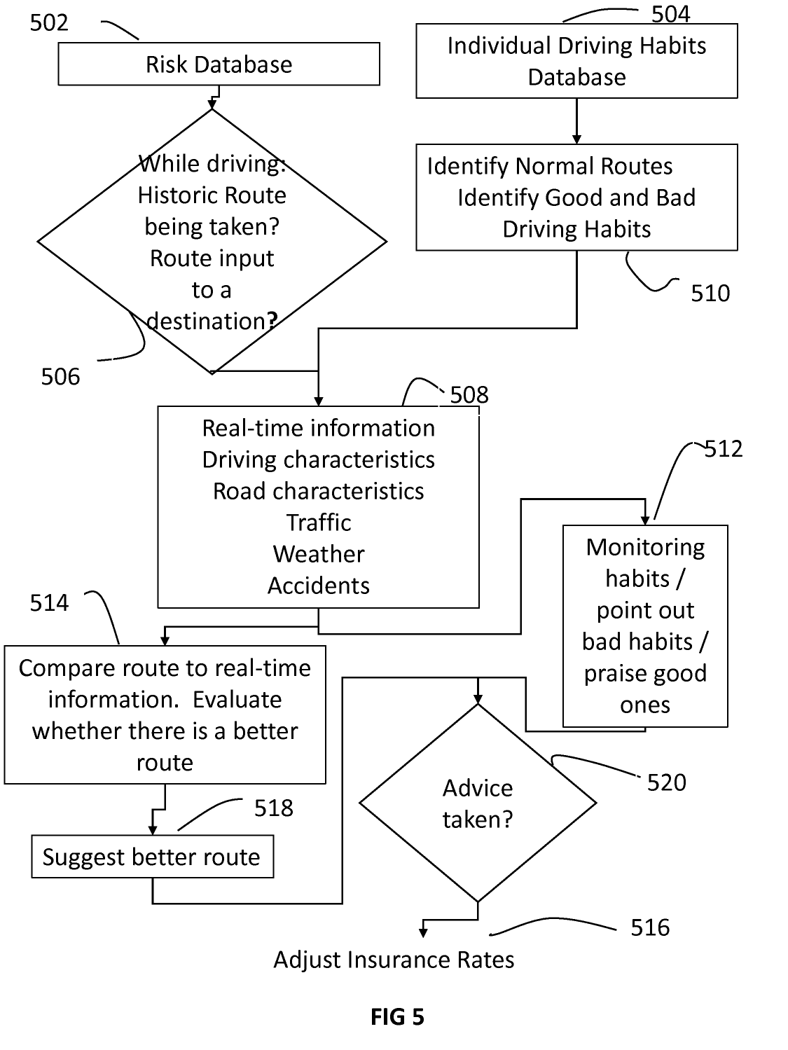

As shown in FIG. 5, starting with the risk database 502 and the driving habits database 504, when a driver starts driving, the system determines whether the driver is driving a historical route, for example, driving towards work at a given time of day, or alternatively if a driver has input a route 506 to a new destination. If a route is being taken, the system next looks for real-time information from external sources of information 508—for example traffic counts, accident reports or reports of lane closures. In addition, weather information along the route could also be acquired. Next, the travel time and risk assessment along the anticipated route is calculated by the navigation device. Alternate routes are also calculated taking into account the real-time information. If an alternate route is found that is safer and/or faster 514, then this information can be displayed to the driver and a selection can be presented to route via the safer or faster route 518. If the safer route is selected 520, then the navigation system can either add an indication into the driver habit database that the advice was taken or this can be transmitted to a server where insurance rates are determined. This information can then be used to affect insurance rates 516.

It should be noted that insurance premiums based in part on driving habits, can be underwritten in a conventional manner for a vehicle, or underwritten for a specific driver as long as when monitoring a vehicle, the driver is identified in some manner and the data acquired and stored is referenced to the specific driver.

In addition, deviations from safer driving habits are monitored during driving 512. If a bad driving habit are detected—say, for example, exceeding the speed limit—advice can be displayed to slow down. If the advice is taken, then this information can be treated as in the above safe route scenario 516.

The present invention may be conveniently implemented using one or more conventional general purpose or specialized digital computers or microprocessors programmed according to the teachings of the present disclosure. Appropriate software coding can readily be prepared by skilled programmers based on the teachings of the present disclosure, as will be apparent to those skilled in the software art.

In some embodiments, the present invention includes a computer program product which is a non-transitory storage medium (media) having instructions stored thereon/in which can be used to program a computer to perform any of the processes of the present invention. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

The foregoing description of the present invention has been provided for the purposes of illustration and description. It is not intended to be exhaustive or to limit the invention to the precise forms disclosed. The embodiments were chosen and described in order to best explain the principles of the invention and its practical application, thereby enabling others skilled in the art to understand the invention for various embodiments and with various modifications that are suited to the particular use contemplated. For example, although the illustrations provided herein primarily describe embodiments using vehicles, it will be evident that the techniques described herein can be similarly used with, e.g., trains, ships, airplanes, containers, or other moving equipment. It is intended that the scope of the invention be defined by the following claims and their equivalence.

What is claimed:

1. A method for determining the risk associated with providing vehicle insurance comprising:
compiling a database of historical information comprising: a plurality of indications of vehicle and driver activities and risk factors wherein the historical information is geo-referenced to transportation elements, and wherein the historical information may be related to insurance risk;
developing a statistical predictive relationship to estimate insurance risk as a function of the historical information for each transportation element wherein the type of historical information is found to have statistical relevance to insurance risk;
monitoring and recording at least one of the vehicle and specific driver activity including both driving habits and when and how often the at least one of the vehicle and driver traverses individual transportation elements;
determining an insurance premium based on: determining when and where a vehicle is traveling or a driver is driving, and using this information as input to the statistical predictive relationship;
acquiring additional geo-referenced risk factors from outside sources;
refining the statistical predictive relationship by incorporating both the recorded at least one of the vehicle and specific driver activity and additional geo-referenced risk factors into the database of historical information and re-developing the statistical predictive relationship; and
at least one of adding new risk factors as statistically significant amounts of data becomes available for the new risk factors and removing risk factors from the predictive model as the impact on the predictive relationship goes below a statistical threshold.

2. The method of claim 1 wherein the risk factors for each transportation element comprise at least one of:
accident counts;
traffic density;
number of driving citations, and
number of insurance claims.

3. The method of claim 2 wherein the risk factors are further referenced or indexed by one or more of: time of day, time of week, and severity of the accident in terms of vehicle damage or passenger injury, type of traffic citation and cost of insurance claims.

4. The method of claim 1 wherein the only risk factor is the number of traffic accidents per transportation segment that is optionally further indexed by one or both of time of day and day of week.

5. The method of claim 1 wherein additional risk factors comprise at least one of the type of vehicle, driver demographics, weather information and pavement conditions.

6. The method of claim 1 wherein the statistical predictive relationship is developed using one of a neural network or machine learning.

7. The method of claim 1 wherein the anticipated accuracy of the predictive function is also presented with a prediction of insurance risk and wherein the anticipated accuracy is based on metadata associated with the historic information for the transportation segments used in the prediction.

8. The method of claim 1 wherein each type of historic information is based on a plurality of disparate sources and wherein the information from the dispirit sources is merged using consistent units of measurement and parameterized into consistent ranges of measure.

9. The method of claims 8 wherein at least one of the disparate sources contains information geo-referenced only to an address and that address is geocoded and snapped to a transportation segment.

10. The method of claim 1 wherein the determined insurance risk associated with transportation segments is productized as attribution associated with a transportation map.

11. The method of claim 1 wherein the insurance risk is collectively determined for a plurality of routes from an origin to a destination and wherein route selection is at least in part based on minimizing the collective risk.

12. The method of claim 11 wherein if a driver follows a determined route that has a minimized collective risk, the driver is provided a discount on insurance premiums.

13. The method of claim 1 wherein additional risk factors comprise at least one of, traffic conditions, accident occurrences, detours, and weather information wherein the additional factors are received in real-time and used to determine immediate risk.

14. The method of claim 13 wherein if the immediate risk of driving exceeds a threshold, and the driver chooses to delay travel until such time as the risk is less, the driver is rewarded with reduced insurance premiums

15. The method of claim 13 wherein the received real-time information is utilized in a route determination wherein route selection is at least in part based on minimizing the collective risk of driving along the route.

16. The method of claim 1 wherein the recorded activity comprises historical routes taken by the specific driver or vehicle and the frequency those routes are taken; and
determining while the vehicle is in motion if it likely that the vehicle is traveling along a frequented route; and
upon finding that a likely route is being taken, calculating alternate routes to the destination of the currently traveled route in order to determine if the alternate route has a lower risk factor;
upon determining that a lower risk factor route is available, presenting that route to the driver.

17. The method of claim 16 wherein if the driver takes the present lower risk route, the driver receives a discount on the driver's insurance premium.

18. The method of claim 1 wherein the insurance premium is periodically adjusted based on the collective exposure to risk for a given period of time.

19. The method of claim 1: wherein the predictive function varies geographically at least by one of the weighting of risk factors and the risk factors that are actually incorporated into the model.

20. The method of claim 1: wherein the historical information and the risk factors consist of entirely of sensor output and derivative of the sensor output from sensors contained within and that are part of the vehicle.

21. A computer-implemented system for determining vehicle or specific driver insurance premiums, said computer-implemented system having at least one computer including a processor and associated memory from which computer instructions are executed by said processor, said system comprising:
a database module configured to compile a database of historical information comprising: a plurality of indications of vehicle and driver activities and risk factors wherein the historical information is geo-referenced to transportation elements, and wherein the historical information may be related to insurance risk;
an insurance risk estimator configured to develop a statistical predictive relationship to estimate insurance risk as a function of the historical information received from the database module for each transportation element wherein the type of historical information is found to have statistical relevance to insurance risk;
a monitoring and recording module configured to monitor and record at least one of the vehicle and specific driver activity including both driving habits and when and how often the at least one of the vehicle and driver traverses individual transportation elements;
a insurance premium generator configured to determine an insurance premium based on when and where a vehicle is traveling or a driver is driving, and using this information as input to the statistical predictive relationship;
a communications module configured to acquire additional geo-referenced risk factors from outside sources; and
the insurance risk estimator further configured to:
refine the statistical predictive relationship by incorporating both the recorded at least one of the vehicle and specific driver activity and additional geo-referenced risk factors into the database of historical information and re-developing the statistical predictive relationship; and
at least one of add new risk factors as statistically significant amounts of data become available for the new risk factors and remove risk factors from the predictive model as the impact on the predictive relationship goes below a statistical threshold.

22. A non-transitory computer readable media containing instructions to implement a system for determining vehicle or specific driver insurance premiums, the system having at least one computer including a processor and associated memory from which the instructions are executed by said processor, said instructions comprising:
compiling a database of historical information comprising: a plurality of indications of vehicle and driver activities and risk factors wherein the historical information is geo-referenced to transportation elements, and wherein the historical information may be related to insurance risk;
developing a statistical predictive relationship to estimate insurance risk as a function of the historical information for each transportation element wherein the type of historical information is found to have statistical relevance to insurance risk;
monitoring and recording at least one of the vehicle and specific driver activity including both driving habits and when and how often the at least one of the vehicle and driver traverses individual transportation elements;
determining an insurance premium based on: determining when and where a vehicle is traveling or a driver is driving, and using this information as input to the statistical predictive relationship;
acquiring additional geo-referenced risk factors from outside sources;
refining the statistical predictive relationship by incorporating both the recorded at least one of the vehicle and specific driver activity and additional geo-referenced risk factors into the database of historical information and re-developing the statistical predictive relationship; and
at least one of adding new risk factors as statistically significant amounts of data becomes available for the new risk factors and removing risk factors from the predictive model as the impact on the predictive relationship goes below a statistical threshold.

23. A method for adjusting vehicle or specific driver insurance premiums comprising the steps of:
1) monitoring and recording a vehicle or specific driver activity including when and how often the vehicle or driver traverses individual transportation elements for a first time period;
2) receiving a risk index for each transportation segment traversed during the first time period;
3) calculating an overall risk index for the vehicle or specific driver for the first time period comprising the summation of each risk index for each traversed transportation segment multiplied by the number of traversals for the first time period;
4) repeating steps 1-3 for a second time period; and
5) if the overall risk index for the second time period is different than the first time period, use this information to adjust insurance premiums up or down.

24. A method for adjusting vehicle or specific driver insurance premiums comprising the steps of:
1) receiving a plurality of requests from a specific driver or passenger of the vehicle, using a navigation device located within the vehicle, for route guidance from a start to a destination;
2) for each routing request, determine possible routes;
3) for each possible route, receive real-time hazard information;
4) for each possible route, calculate the relative risk of taking that route;
5) present the driver or passenger of the vehicle with one or more of the safest routes;
6) monitor the vehicle movement and determine if the vehicle has taken one or the safest routes, provided that the vehicle travels to the destination;
7) record over a time period, the amount of safe routes taken and the amount of less safe routes taken; and
8) use the ratio of safe routes taken when compared to less safe routes to adjust insurance premiums up or down.

25. A computer-implemented system for determining a safe route from an origin to a destination, said computer-implemented system having at least one computer including a processor and associated memory from which computer instructions are executed by said processor, said system comprising:
a database module configured to store historical information related to driving risk and that is geo-referenced to transportation elements;
a monitoring system configured to acquire real-time driving risk information along potential routes from the origin to the destination; and
a route calculator configured to determine a safe route from an origin to a destination in part based on the historical driving risk information and the real-time driving risk information.

26. The computer-implemented system of claim 25 wherein the at least one computer is a navigation system located within a vehicle.

27. The computer-implemented system of claim 25 wherein the system is accessible to an end-user via a network and is provided as software as a service.
